(19) United States
(12) Patent Application Publication
(10) Pub. No.: US 2004/0139173 A1
(43) Pub. Date: Jul. 15, 2004

(54) Media processing system automatically offering access to newly available media in a media exchange network

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,653

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/443,996, filed on Jan. 30, 2003.

(51) Int. Cl. G06F 15/16

(52) U.S. Cl. 709/219

(57) ABSTRACT

Aspects of the invention provide a method and system for communication of information in a distributed media network. Information communication in a distributed media network may include detecting availability of new media, data and/or service within the distributed network. At least one media processing system having an interest in monitoring the newly available media, data and service may be identified. The media processing system may be notified of the newly available media, data and/or service. The method may further include comparing the newly available media, data and/or service with data in a media profile associated with the media processing system to determine whether there is a match. In the case of a match, the media processing system may be subsequently notified of the match. Although the data in the media profile associated with the media processing system may be predefined, the media profile may also be dynamically updated.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/443,996 (Attorney Docket No. 14281US01 01009P-BP-2807) filed Jan. 30, 2003.

This application also makes reference to:

U.S. application Ser. No. ______ (Attorney Docket No. 14185US02 01001P-BP-2800) filed Sep. 8, 2003; and

U.S. application Ser. No. ______ (Attorney Docket No. 14274US02 01002P-BP-2801) filed Sep. 11, 2003.

All of the above stated applications are incorporated herein by reference in their entirety.

### FIELD OF THE INVENTION

Certain embodiments of the invention relate to information storage. More specifically, certain embodiments of the invention relate to a media processing system offering access to newly available media in a media exchange network.

### BACKGROUND OF THE INVENTION

A personal computer (PC) employing a web browser is often used by a user to grant permission to a third party to provide awareness of newly available media, data, and/or services provided by that third party. The third party may then send updates to the user, via email, to make the user aware of the newly available media, data, and/or services. For example, a user may give permission to a book publisher to make the user aware of new books that are published and/or distributed in a certain category. Exemplary categories may include science, arts, business, investments, health, literature, home, gardening and spirituality. Interactive TV services are sometimes provided via set-top-boxes using a similar kind of browser and, essentially, merely replicates the same web site functionality provided by a PC.

Often, a user may not be aware of third party web sites that are available via the Internet and any corresponding type of media, data, and/or services that may be provided. Furthermore, a user or subscriber may be informed of any newly available media, data, and/or services that may have been posted to those web sites. A user or subscriber may typically have to use a search engine service to look for web sites in order to locate and identify available media, data, and/or services that may be interest to the user. This can be a time-consuming and frustrating exercise, especially if the user is searching for media, data, and/or services that do not exist or may not be readily available on the Internet. In instances where a user may have knowledge that certain data may be located on a particular web site, the user often has to go to that web site using his PC and/or browser in order to find out what may be newly available.

Also, a PC is often used to access media stored on a media peripheral via a wired link. The accessing of media stored on such media peripherals involves tasks such as exchanging media meta information, uploading of media to a media peripheral and downloading of media from the media peripheral. Exemplary media meta information may include media file names, sizes, dates, resolution and format. As a result, a user or subscriber may have the capability to extract media for printing, routing, or processing, or for load media for playback or review. In this regard, the overall process for accessing and/or exchanging information is a manual process that may require significant user interaction and time.

For example, in the case of using a digital camera, a user may not remember if any recent digital pictures are currently stored on the camera and have not yet been downloaded to his PC. As a result, the user: (1) removes the digital camera from its case; (2) attaches a cable between the PC and the digital camera; (3) powers up the digital camera; (4) places the camera in a download mode; (5) runs a PC application that copies any image files from the digital camera to the PC via the cable; (6) powers down the digital camera; (7) removes the cable; (8) places the camera into its case; (9) exits the PC application, and then searches through the downloaded digital pictures on his PC to see if there are any new pictures in the bunch. This process is very tedious and time consuming, and, especially when problems arise, requires a fairly savvy user.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Certain embodiments of the invention provide a method and system for communication of information in a distributed media network. The method for communication of information in a distributed media network may include detecting availability of new media, data and/or service within the distributed network. At least one media processing system having an interest in monitoring the newly available media, data and service may be identified. The media processing system may be notified of the newly available media, data and/or service. The method may further include comparing the newly available media, data and/or service with data in a media profile associated with the media processing system to determine whether there is a match. In the case of a match, the media processing system may be subsequently notified of the match. Although the data in the media profile associated with the media processing system may be predefined, the media profile may also be dynamically updated.

The method for communication of information may also include polling at least one network component in the distributed media network to determine the availability of the new media, data and/or service. The network components may be any one or more of a personal computer, a server, a content provider and a media processing server. In another aspect of the invention, a media processing system may subscribe to receive notifications of new media, data and/or service. Information communicated by the media processing system may be examined to determine data associated with the monitored interest. Once the determined data associated with the monitored interest matches the newly available media, data and/or service, the corresponding media processing system may be notified. In another aspect of the invention, a media profile corresponding to the determined data associated with the monitored interest may be updated. At least one media view may be updated with data associated with the newly available media, data and/or service.

Another embodiment of the invention may provide a machine-readable storage, having stored thereon, a computer program having at least one code section for providing communication of information in a distributed media network. The at least one code section may be executable by a machine, thereby causing the machine to perform the step of detecting the availability of new media, data and/or service within the distributed network. At least one code section may identify a media processing system having an interest in monitoring the newly available media, data and service. At least one code section may notify the media processing system of the newly available media, data and/or service. A comparing code section may compare the newly available media, data and/or service with data in a media profile associated with the media processing system to determine whether there is a match. In the case of a match, the notification code may notify the media processing system of the match. Notwithstanding, although the data in the media profile associated with the media processing system may be predefined, the media profile may also be dynamically updated.

The machine-readable storage for communication of information may also include code for polling at least one network component in the distributed media network to determine the availability of the new media, data and/or service. The network components may be any one or more of a personal computer, a server, a content provider and a media processing server. In another aspect of the invention, at least one code section may be provided that may permit a media processing system to subscribe to receive notifications of new media, data and/or service. Code may be provided that permits information communicated by the media processing system to be examined to determine data associated with the monitored interest. Once the determined data associated with the monitored interest matches the newly available media, data and/or service, the corresponding media processing system may be notified. In another aspect of the invention, code may be provided that allows a media profile corresponding to the determined data associated with the monitored interest to be updated. Accordingly, code may also be provided to update at least one media view with data associated with the newly available at least one of new media, data and service.

Another embodiment of the invention may include a system for communication of information in a distributed media network. The system may include at least one processor that may detect availability of new media, data and/or service within the distributed network. The processor may identify at least one media processing system having an interest in monitoring the newly available media, data and service. The processor may notify the media processing system of the newly available media, data and/or service. The processor may compare the newly available media, data and/or service with data in a media profile associated with the media processing system to determine whether there is a match. In the case of a match, the media processing system may be subsequently notified of the match. Although the data in the media profile associated with the media processing system may be predefined, the media profile may also be dynamically updated.

The processor may poll at least one network component in the distributed media network to determine the availability of the new media, data and/or service. The network components may be any one or more of a personal computer, a server, a content provider and a media processing server. In another aspect of the invention, a media processing system may subscribe to receive notifications of new media, data and/or service. The processor may examine information communicated by the media processing system in order to determine data associated with the monitored interest. Once the determined data associated with the monitored interest matches the newly available media, data and/or service, the corresponding media processing system may be notified. In another aspect of the invention, a media profile corresponding to the determined data associated with the monitored interest may be updated by the processor and/or the media processing system. The processor and/or the media processing system may update at least one media view with data associated with the newly available media, data and/or service.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an embodiment of an exemplary media exchange network supporting automatic access to newly available media, data, and services in accordance with various aspects of the present invention.

FIG. 2A is a flowchart illustrating a first embodiment of a method for automatically accessing newly available media, data, and services on the media exchange network of FIG. 1, in accordance with various aspects of the present invention.

FIG. 2B is a flowchart illustrating a second embodiment of a method for automatically accessing newly available media, data, and services on the media exchange network of FIG. 1, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the present invention relate to the availability of media, data, and services on a media exchange network. In particular, certain embodiments of the present invention relate to providing automatic access to newly available media, data, and services by a media processing system (MPS) in a media exchange network.

Aspects of the invention provide a method and system for communication of information in a distributed media network. The communication of information may include detecting availability of new media, data and/or service within the distributed network. A media processing system having an interest in monitoring the newly available media, data and service may be identified and notified of the newly available media, data and/or service. The newly available media, data and/or service may be compared with data in a media profile associated with the media processing system to determine whether there is a match. If there is a match, the media processing system may be notified of the match. Although the data in the media profile associated with the media processing system may be predefined, the media profile may also be dynamically updated and account for real time changes.

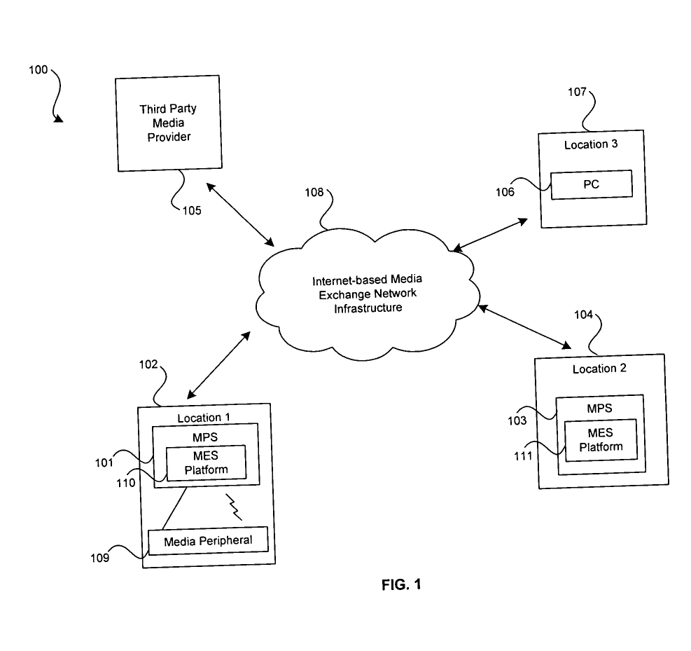

FIG. 1 is a diagram illustrating an embodiment of an exemplary media exchange network 100 supporting automatic access to newly available media, data, and services in accordance with various aspects of the present invention. Specifically, a media exchange network 100 may be a communication network, which may include a first media processing system (MPS) 101 situated at a first location 102 such as a user's home of the media exchange network 100 and a second MPS 103 situated at a second location 104 such as a family member's home. The media exchange network 100 may also include a third (3^{rd}) party media provider 105, a PC 106 situated at third location 107 such as a friend's home, and an Internet-based media exchange network infrastructure 108. The MPS's 101 and 103, the PC 106, and the third (3^{rd}) party media provider 105 may each connect to the Internet-based media exchange network infrastructure 108 to allow communication between the various components 101, 103, 105, and 106. The first location 102, the user's or subscriber's home, may also include a media peripheral 109 interfacing, via a wired or wireless connection, to the MPS 101.

The MPS 101 comprises a MES (media exchange software) platform 110 and the MPS 103 comprises a similar MES platform 111. In general, a MES platform provides certain functionality within a MPS such as the ability to search for media, data, and/or services on a media exchange network. Also, a MES platform provides the capability for a user or subscriber to construct a user profile and register their MPS on the media exchange network.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The various components of the media exchange network may be adapted to or have the capability to store digital media and data. For example, the third (3^{rd}) party media provider 105 may include a server that may store movies in a digital video format such as MPEG and its variants. The media peripheral 109 may comprise a digital camera storing pictures in digital image form. The PC 106 may store music as MP3 or .wav files, for example, at friend's home 107. The MPS 103 at location 104, the family member's home, may store family photos in a digital image format, such as JPEG, GIF or bitmap.

The MPS's 101 and 103 may comprise main storage and removable storage. The main storage may comprise, for example, hard disk drives, a DVD player, a CD player, floppy disk drives, RAM, or any combination of these. The removable storage may include, for example, memory sticks, SD memory cards, PCM/CIA cards, compact flash cards, or any combination of these. The PC 106 may comprise a desktop PC, a notebook PC, a PDA, or any computing device.

The media peripheral 109 may include, for example, a digital camera, a digital camcorder, an MP3 player, a home juke-box system, a PDA (personal digital assistant), and a multi-media gateway device. The MPS's (101, 103) each include a TV screen for viewing a list of newly available media, data, and services on the media exchange network 100.

The Internet-based media exchange network infrastructure 108 may include, for example, cable infrastructure, satellite network infrastructure, DSL infrastructure, Internet infrastructure, and/or intranet infrastructure providing wide area network (WAN) capability. The Internet-based media exchange network infrastructure 108 may provide a medium that may facilitate the exchange of information among the first location 102, second location 104, third location 107 and the third party media provider. Generally, the Internet-based media exchange network infrastructure 108 may provide wired, wireless and any hybrid thereof for transporting or communication information.

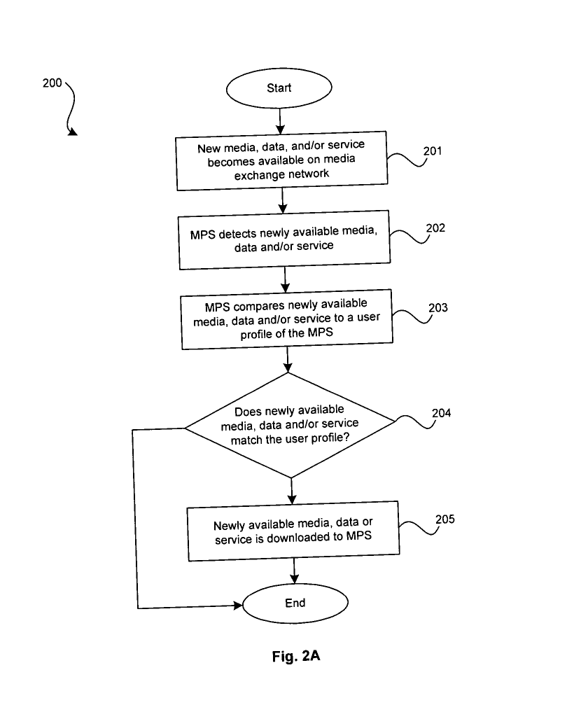

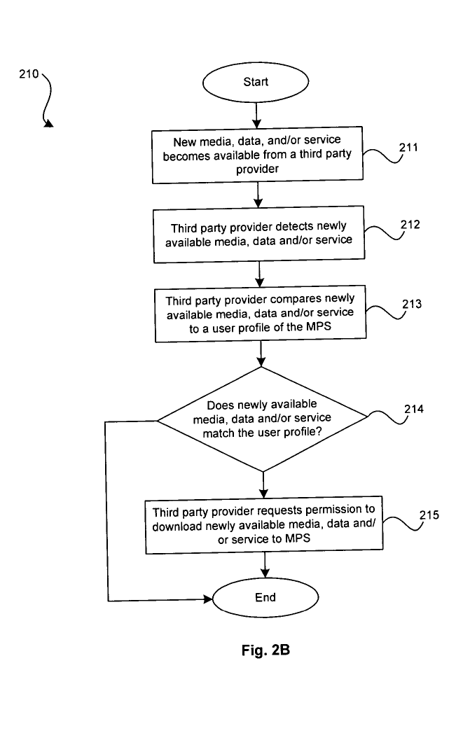

FIG. 2A is a flowchart illustrating a first embodiment of a method 200 for automatically accessing newly available media, data, and services on the media exchange network 100 of FIG. 1, in accordance with various aspects of the present invention. In step 201, a new media, data, and/or service becomes available on the media exchange network 100. In step 202, the MPS 101 detects the newly available media, data, or service. In step 203, the MPS 101 compares the newly available media, data, or service to a user profile. In step 204, the MPS decides if the newly available media, data, or service matches the user profile. If the newly available media, data, or service matches the user profile then, in step 205, the MPS 101 may be notified of the newly available media. The newly available data may be subsequently downloaded.

In one embodiment of the invention, in step 205, only an indication of the presence of the newly available media, data, and/or service may be downloaded to the MPS 101. The actual media, data, or service may be downloaded at a later time upon selection by a user.

In accordance with an embodiment of the present invention, an MPS may continuously or periodically search a media exchange network for newly available media, data, and services. Accordingly, periodic searching may be scheduled to occur at specific times and/or on certain designated network components. Also, searching may be done based on user authorization. For example, a 3^{rd} party provider, whose media exchange network registration number is not entered into MPS 101, may not be polled by MPS 101.

For example, a user of MPS 101 may set up a user profile, using a remote control 112 in conjunction with his MPS 101, indicating that the user is interested in Ford mustang cars. The MES platform 110 of MPS 101 provides the functionality for the MPS 101 to automatically search the media exchange network 100 and poll the various components on the media exchange network 100 for newly available media, data, and services related to the contents of the user profile, that is Ford mustang cars. As an option, the MPS 101 may only poll those components of the media exchange network 100 whose registration numbers are authorized by MPS 101.

As defined herein, newly available media, data, and services are those media, data, and services currently available on the media exchange network 100 that were not previously available the last time the MPS 101 performed a search on the media exchange network 100.

For example, if a newly available media such as an advertisement for a 1965 Ford mustang vehicle is found by MPS 101 to exist on the third (3^{rd}) party media provider 105, then the advertisement may be downloaded to MPS 101 via the internet-based media exchange network infrastructure 108. Alternatively, only an indication of the existence of the advertisement could be downloaded and the user of MPS 101 could choose to download the actual advertisement at a later time.

FIG. 2B is a flowchart illustrating a second embodiment of a method 210 for automatically accessing newly available media, data, and services on the media exchange network 100 of FIG. 1, in accordance with various aspects of the present invention. In step 211, a new media, data, or service becomes available from a 3^{rd} party provider 105 on the media exchange network 100. In step 212, the third (3^{rd}) party provider detects the MPS 101 on the media exchange network 100. In step 213, the third (3^{rd}) party provider compares the newly available media, data, or service to a user profile of the MPS 101. In step 214, the third (3^{rd}) party provider 105 decides if the newly available media, data, or service matches the user profile. If the newly available media, data, or service matches the user profile then, in step 215, the third (3^{rd}) party provider sends a message to the MPS 101 requesting permission to download the newly available media, data, or service to the MPS 101. As an option, the third (3^{rd}) party media provider 105 may only be able to access the user profile of MPS 101 if MPS 101 has authorized such access based on the registration number of the third (3^{rd}) party media provider 105.

For example, a user of MPS 101 may have set up a user profile, using a remote control 112 in conjunction with her MPS 101, indicating that she is interested in gardening. The third (3^{rd}) party provider 105 provides the functionality to automatically search the media exchange network 100 for MPS's and access their user profiles.

If a newly available service (e.g., annual shipment of flower seeds) is made available by third (3^{rd}) party media provider 105, then the third (3^{rd}) party provider may request permission, via the user's MPS 101, to download the details of the service, and how to sign up for the service, to MPS 101 via the internet-based media exchange network infrastructure 108. When the user views the request on a TV screen of his MPS 101, she may use her remote control to accept or reject the request.

In accordance with an embodiment of the present invention, if a media peripheral 109 comes into proximity of the MPS 101, the MPS 101 may detect the presence of the media peripheral 109 and poll the media peripheral 109 for new media content. For example, a user, after taking pictures with his digital camera out in the woods, may come home with his digital camera. Once the digital camera is within a certain range of the user's MPS, a wireless link may be automatically established between the MPS and the digital camera. The recently taken (i.e., newly available) digital pictures may be automatically downloaded to the MPS 101. Also, the digital pictures may then be automatically pushed from MPS 101 to MPS 103, for example, at the family member's home 104.

As another example, a user's friend at the friend's home 107 may load some new MP3 files onto his PC 106. The MPS 101 may poll the PC 106 and detect the presence of the new MP3 files on the PC 106 via the Internet-based media exchange network infrastructure 108. In this regard, the MPS 101 will know the specific files that are in the PC 106. Accordingly, the MPS 101 may then request that the newly available MP3 files be downloaded to the MPS 101 at user's home 102.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

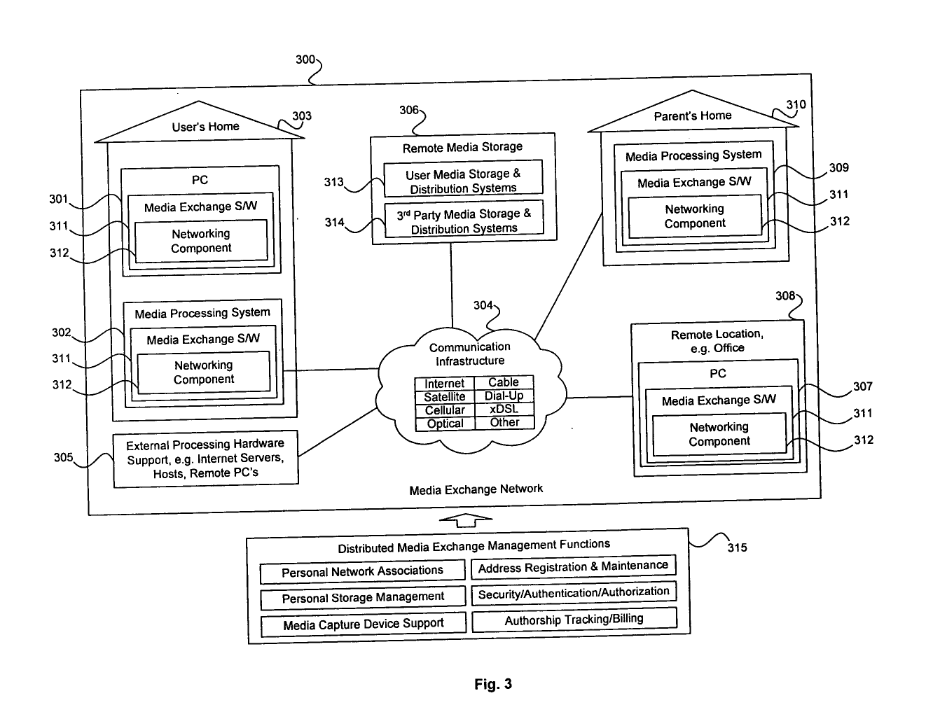

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

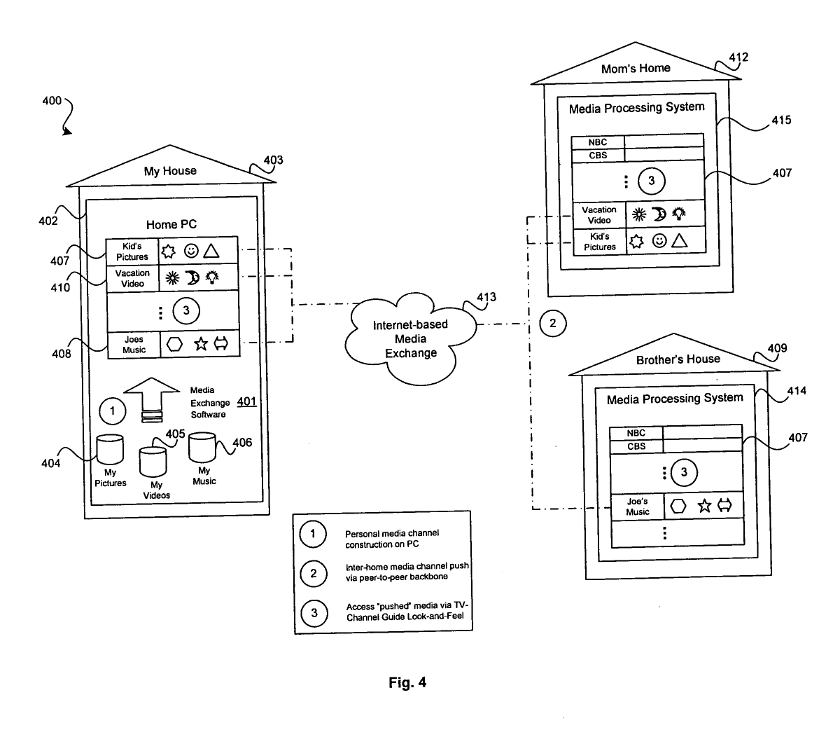

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

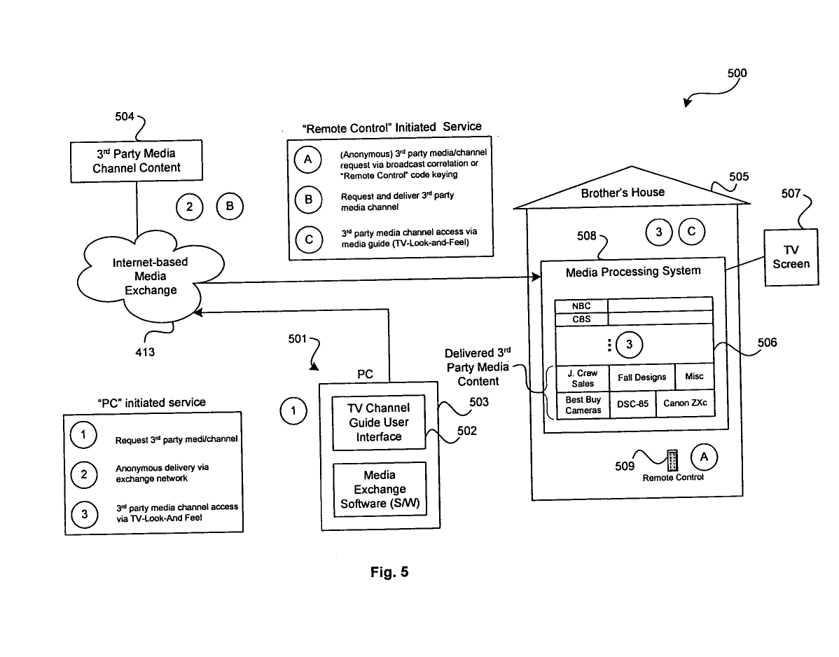

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

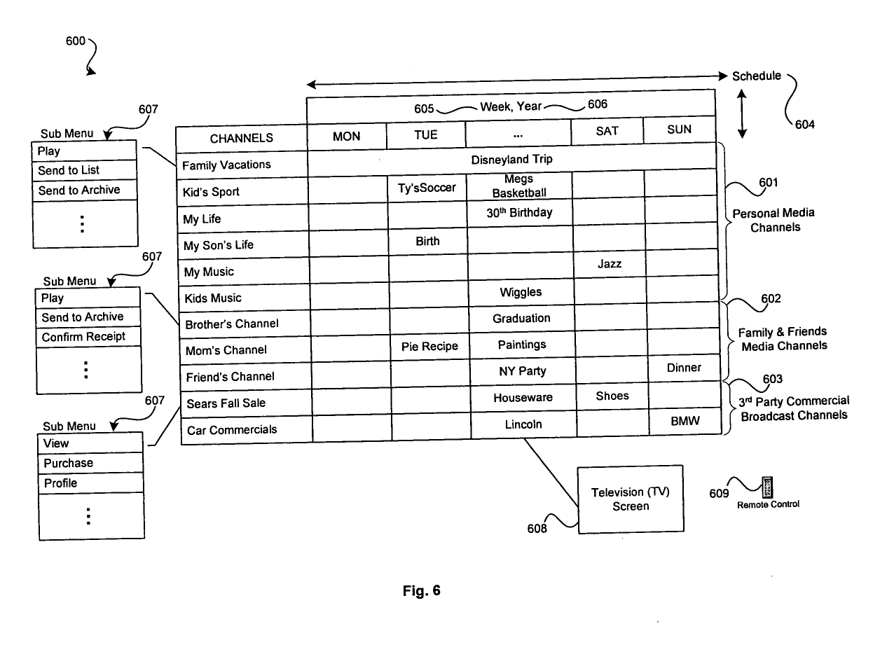

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

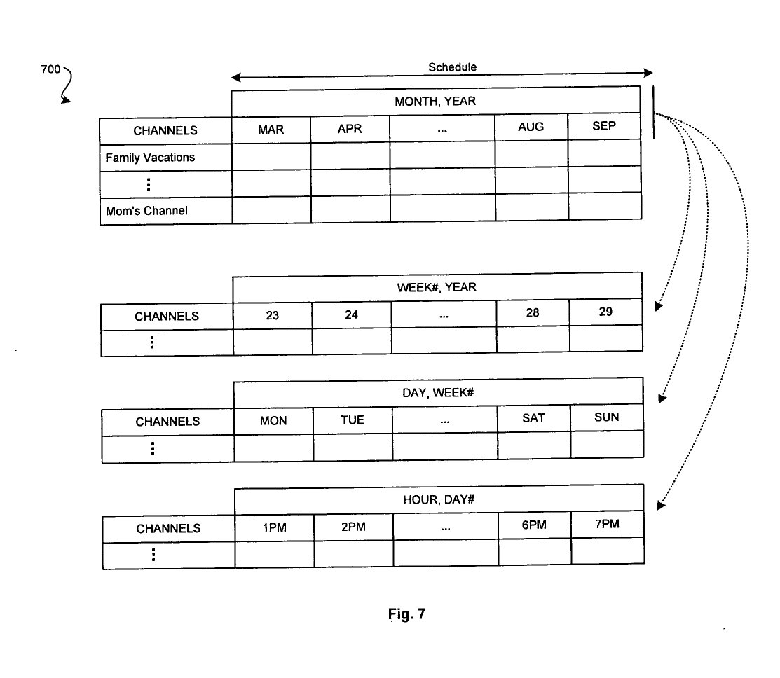

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

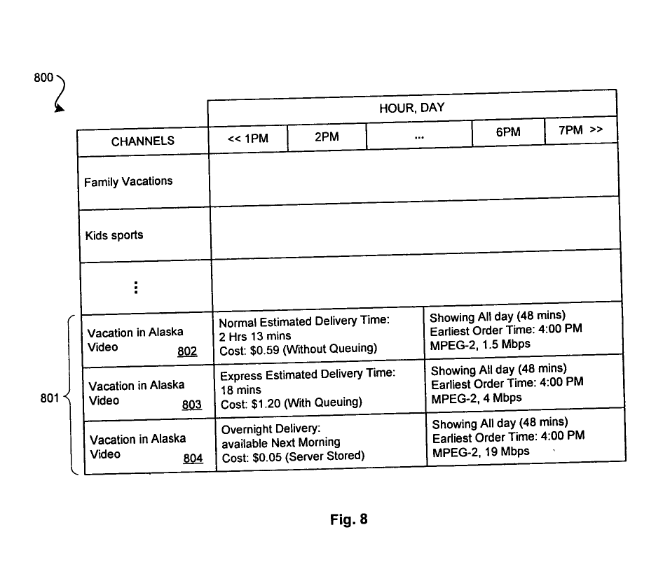

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

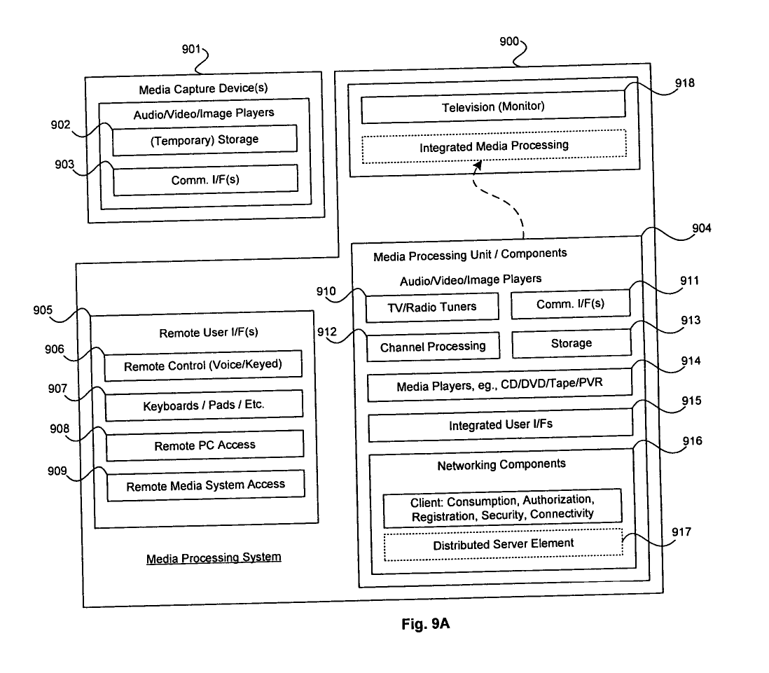

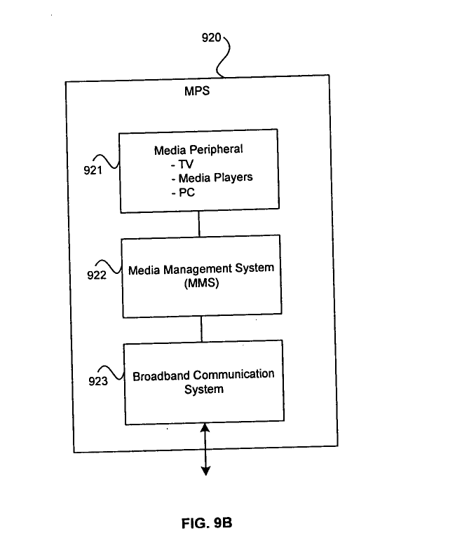

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

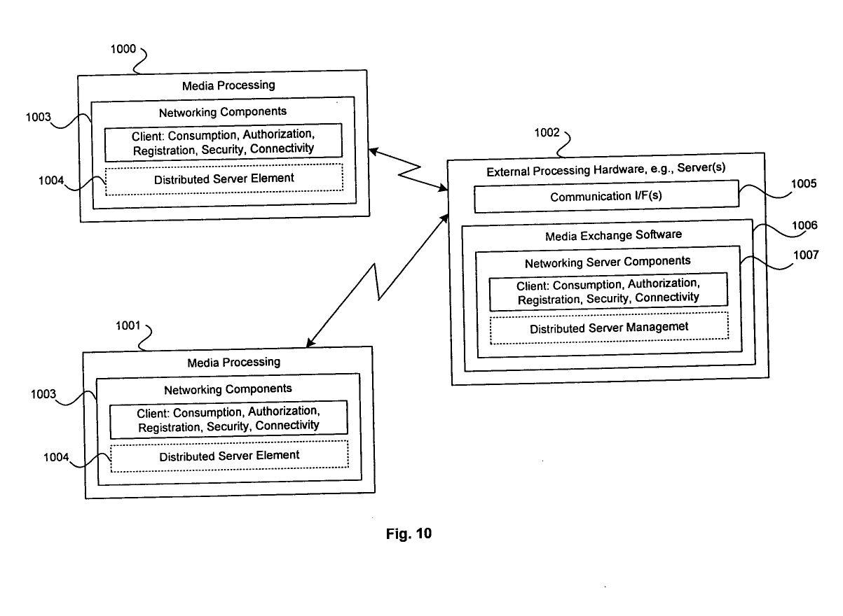

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

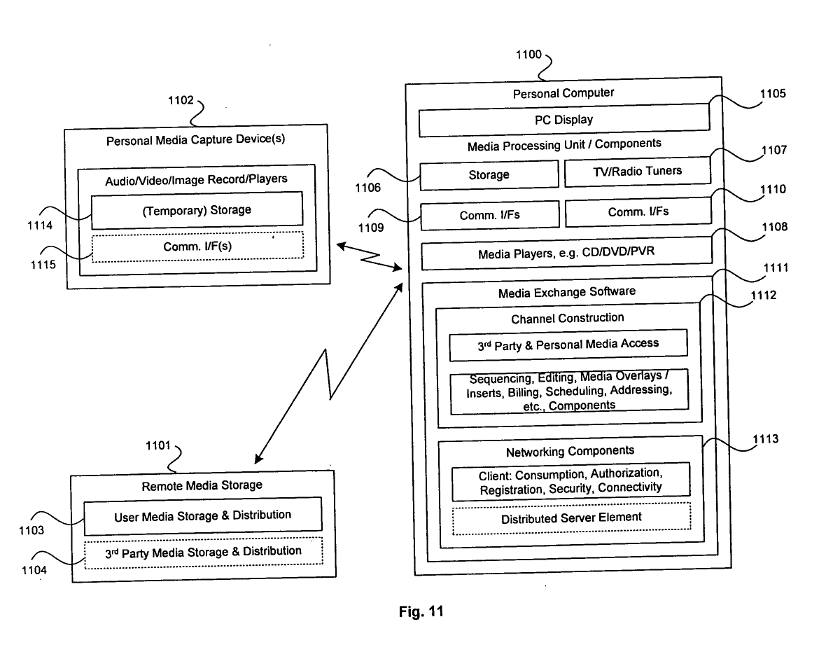

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

In summary, the communication of information in a distributed media network may include detecting availability of new media, data and/or service within the distributed network. A media processing system having an interest in monitoring the newly available media, data and service may be identified and notified of the newly available media, data and/or service. The newly available media, data and/or service may be compared with data in a media profile associated with the media processing system to determine whether there is a match. If there is a match, the media processing system may be notified of the match. Although the data in the media profile associated with the media processing system may be predefined, the media profile may also be dynamically updated and account for real time changes.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication of information in a distributed media network, the method comprising:
detecting availability of at least one of new media, data and service within the distributed media network;
identifying at least one media processing system having an interest in monitoring said newly available at least one of new media, data and service; and
notifying said identified at least one media processing system of said newly available at least one of new media, data and service.

2. The method according to claim 1, further comprising comparing said newly available at least one of new media, data and service with data in a media profile associated with said at least one media processing system to determine whether there is a match.

3. The method according to claim 2, wherein said data in said media profile associated with said at least one media processing system is predefined.

4. The method according to claim 2, further comprising dynamically updating data in said media profile associated with said at least one media processing system.

5. The method according to claim 1, further comprising polling at least one of a plurality of network components in the distributed media network for said newly available at least one of new media, data and service.

6. The method according to claim 5, wherein said at least one of a plurality of network components is at least one of a personal computer, a server, a content provider and a media processing server.

7. The method according to claim 1, further comprising subscribing to receive said notification.

8. The method according to claim 1, further comprising examining information communicated by said media processing system to determine data associated with said monitored interest.

9. The method according to claim 8, further comprising updating a media profile associated with said determined data associated with said monitored interest.

10. The method according to claim 9, further comprising updating at least one media view with data associated with said newly available at least one of new media, data and service.

11. A machine-readable storage having stored thereon, a computer program having at least one code section for communicating information in a distributed media network, the at least one code section being executable by a machine for causing the machine to perform steps comprising:
detecting availability of at least one of new media, data and service within the distributed media network;
identifying at least one media processing system having an interest in monitoring said newly available at least one of new media, data and service; and
notifying said identified at least one media processing system of said newly available at least one of new media, data and service.

12. The machine-readable storage according to claim 11, further comprising code for comparing said newly available at least one of new media, data and service with data in a media profile associated with said at least one media processing system to determine whether there is a match.

13. The machine-readable storage according to claim 12, wherein said data in said media profile associated with said at least one media processing system is predefined.

14. The machine-readable storage according to claim 12, further comprising code for dynamically updating data in said media profile associated with said at least one media processing system.

15. The machine-readable storage according to claim 11, further comprising code for polling at least one of a plurality of network components in the distributed media network for said newly available at least one of new media, data and service.

16. The machine-readable storage according to claim 15, wherein said at least one of a plurality of network components is at least one of a personal computer, a server, a content provider and a media processing server.

17. The machine-readable storage according to claim 11, further comprising code for subscribing to receive said notification.

18. The machine-readable storage according to claim 11, further comprising code for examining information communicated by said media processing system to determine data associated with said monitored interest.

19. The machine-readable storage according to claim 18, further comprising code for updating a media profile associated with said determined data associated with said monitored interest.

20. The machine-readable storage according to claim 19, further comprising code for updating at least one media view with data associated with said newly available at least one of new media, data and service.

21. A system for communication of information in a distributed media network, the system comprising:
at least one processor adapted to detect availability of at least one of new media, data and service within the distributed media network;
said at least one processor identifying at least one media processing system having an interest in monitoring said newly available at least one of new media, data and service; and
said at least one processor notifying said identified at least one media processing system of said newly available at least one of new media, data and service.

22. The system according to claim 21, wherein said at least one processor compares said newly available at least one of new media, data and service with data in a media profile associated with said at least one media processing system to determine whether there is a match.

23. The system according to claim 22, wherein said data in said media profile associated with said at least one media processing system is predefined.

24. The system according to claim 22, wherein said at least one processor dynamically updates data in said media profile associated with said at least one media processing system.

25. The system according to claim 21, wherein said at least one processor polls at least one of a plurality of network components in the distributed media network for said newly available at least one of new media, data and service.

26. The system according to claim 25, wherein said at least one of a plurality of network components is at least one of a personal computer, a server, a content provider and a media processing server.

27. The system according to claim 21, wherein said at least one media processing system subscribes to receive said notification.

28. The system according to claim 21, wherein said at least one processor examines information communicated by said media processing system to determine data associated with said monitored interest.

29. The system according to claim 28, wherein said at least one processor updates a media profile associated with said determined data associated with said monitored interest.

30. The system according to claim 29, wherein at least one of said at least one processor and said media processing system updates at least one media view with data associated with said newly available at least one of new media, data and service.
